(19) United States
(12) Patent Application Publication
(10) Pub. No.: US 2023/0135578 A1
(43) Pub. Date: May 4, 2023

(54) METHOD AND APPARATUS FOR GENERATING STRUCTURED TRAJECTORIES FROM GEOSPATIAL OBSERVATIONS

(71) Applicant: HERE GLOBAL B.V., Eindhoven (NL)

(72) Inventors: Tero KESKI-VALKAMA, Zurich (CH); David JONIETZ, Zurich (CH); Huzefa CALCUTTAWALA, Mumbai (IN)

(21) Appl. No.: 17/452,821

(22) Filed: Oct. 29, 2021

(51) Int. Cl. G06F 30/18; H04W 12/02; G08G 1/0969; B60W 60/00

(52) U.S. Cl. CPC G06F 30/18; H04W 12/02; G08G 1/0969; B60W 60/001

(57) ABSTRACT

A method, apparatus and computer program product are provided for generating structured trajectories based on probe data while maintaining privacy and user information, and generating a map representation of a road network from the structured trajectories. Methods may include: receiving a plurality of trajectories of probe data points from a plurality of probe apparatuses; identifying splitting points in each of the plurality of trajectories of probe data points; identifying legs of the plurality of trajectories of probe data points between pairs of splitting points; assigning legs into bunches of legs; searching a solution space determined by leg bunch assignments; determining, from the bunches of legs, a selected solution representing a map of a road network; and facilitating at least one of navigational assistance or at least semi-autonomous vehicle control using the map of the road network.

### TECHNOLOGICAL FIELD

Example embodiments of the present invention relate generally to generation of structured trajectories from geospatial observations, and more particularly, to the generation of structured trajectories based on probe data while maintaining privacy and user information.

### BACKGROUND

Road geometry modelling is very useful for map creation and terrain identification along with feature and obstacle detection in environments, each of which may facilitate autonomous vehicle navigation along a prescribed path. Traditional methods for 3D modelling of road geometry and object or feature detection are resource intensive, often requiring significant amounts of human measurement and calculation. Such methods are thus time consuming and costly. Exacerbating this issue is the fact that many modern-day applications (e.g., 3D mapping, terrain identification, or the like) require manual or semi-automated analysis of large amounts of data, and therefore are not practical without quicker or less costly techniques.

The use of these maps for navigation and autonomous vehicle control relies on map-matching locations of vehicles to underlying road maps to facilitate navigation, vehicle control, and any location-based services. Further, map-matching is used to establish the position of a vehicle or mobile device within an environment. This map-matching process is resource intensive and requires processing capacity in addition to any latency that may be experienced. Further, map-matching of a vehicle or mobile device to a location within a map can present privacy issues. Map-matching reduces the information in the location trajectories and can therefore hinder or prevent specific downstream uses cases of the data. Storing trajectories in raw form without map-matching can inadvertently allow re-association of the trajectory to a specific vehicle or person, thus creating a privacy risk.

### BRIEF SUMMARY

Accordingly, a method, apparatus, and computer program product are provided for generation of structured trajectories from geospatial observations, and more particularly, to the generation of structured trajectories based on probe data, and using properties of the structured trajectories for provision of location-based services. In a first example embodiment, an apparatus is provided including at least one processor and at least one memory including computer program code, the at least one memory and the computer program code may be configured to, with the at least one processor, cause the apparatus to: receive a plurality of sequences of probe data points from a plurality of probe apparatuses; identify splitting points in each of the plurality of sequences of probe data points; identify legs of the plurality of sequences of probe data points between pairs of splitting points; group legs into bunches of legs; perform a guided search of a solution space containing the bunches of legs by performing successive mutations on candidate solutions in the solution space to identify a solution satisfying a fitness metric threshold; and identify, from the solution satisfying a fitness metric threshold, a road network.

According to an example embodiment, causing the apparatus to identify splitting points in each of the plurality of sequences of probe data points includes causing the apparatus to: identify a starting point of each of the plurality of sequences of probe data points as a fixed splitting point; identify an ending point of each of the plurality of sequences of probe data points as a fixed splitting point; and identify a subset of probe data points of each of the plurality of sequences of probe data points as candidate splitting points. Causing the apparatus of some embodiments to perform a guided search of the solution space containing the bunches of legs by performing successive mutations on candidate solutions in the solution space to identify the solution satisfying the fitness metric includes causing the apparatus to change the subset of points of each of the plurality of sequences of probe data points identified as the candidate splitting points in the successive mutations on candidate solutions to increase the fitness metric.

The fitness metric of some embodiments includes a score reflecting one or more of: lengths of the bunches of legs, a number of bunches, a number of legs within the bunches, or a distance metric between the legs within a respective bunch of legs. The predefined degree of similarity of an example embodiment includes starting points within a predefined distance of one another and ending points within a predefined distance of one another. The predefined degree of similarity optionally includes a trajectory between the starting points and ending points within a predefined Fréchet distance measure. Causing the apparatus to identify, from the solution satisfying the fitness metric, the road network includes, in some embodiments, causing the apparatus to identify the road network without relying on underlying map data of an existing road network.

Embodiments provided herein include a computer program product including at least one non-transitory computer-readable storage medium having computer-executable program code instructions stored therein, the computer-executable program code instructions including program code instructions to: receive a plurality of sequences of probe data points from a plurality of probe apparatuses; identify splitting points in each of the plurality of sequences of probe data points; identify legs of the plurality of sequences of probe data points between pairs of splitting points; group legs into bunches of legs; perform a guided search of a solution space containing the bunches of legs by performing successive mutations on candidate solutions in the solution space to identify a solution satisfying a fitness metric threshold; and identify, from the solution satisfying the fitness metric threshold, a road network.

The program code instructions to identify splitting points in each of the plurality of sequences of probe data points includes program code instructions to: identify a starting point of each of the plurality of sequences of probe data points as a fixed splitting point; identify an ending point of each of the plurality of sequences of probe data points as a fixed splitting point; and identify a subset of points of each of the plurality of sequences of probe data points as candidate splitting points. The program code instructions to perform a guided search of a solution space containing the bunches of legs by performing successive mutations on candidate solutions in the solution space to identify a solution satisfying a fitness metric includes, in some embodiments, program code instructions to: change the subset of points of each of the plurality of sequences of probe data points identified as the candidate splitting points in the successive mutations on candidate solutions to increase the fitness metric.

According to some embodiments, the fitness metric includes a score reflecting one or more of lengths of the bunches of legs, a number of bunches, a number of legs within the bunches, or a distance metric between the legs within a respective bunch of legs. The program code instructions to group legs into bunches of legs include program code instructions to group legs into bunches of legs based on a predefined similarity between legs of a group, where the predefined degree of similarity includes starting points within a predefined distance of one another and ending points within a predefined distance of one another. The predefined degree of similarity of some embodiments further includes trajectories between the starting points and the ending points within a predefined Fréchet distance measure. The program code instructions to identify, from the solution satisfying a fitness metric, the road network include program code instructions to identify the road network without relying on underlying map data of an existing road network.

Embodiments described herein include a method including: receiving a plurality of sequences of probe data points from a plurality of probe apparatuses; identifying splitting points in each of the plurality of sequences of probe data points; identifying legs of the plurality of sequences of probe data points between pairs of splitting points; grouping legs into bunches of legs; performing a guided search of a solution space containing the bunches of legs by performing successive mutations on candidate solutions in the solution space to identify a solution satisfying a fitness metric threshold; and identifying, from the solution satisfying a fitness metric threshold, a road network.

According to some embodiments, identifying splitting points in each of the plurality of sequences of probe data points includes: identifying a starting point of each of the plurality of sequences of probe data points as a fixed splitting point; identifying an ending point of each of the plurality of sequences of probe data points as a fixed splitting point; and identifying a subset of points of each of the plurality of sequences of probe data points as candidate splitting points. Performing the guided search of the solution space containing the bunches of legs by performing successive mutations on candidate solutions in the solution space to identify the solution satisfying the fitness metric includes, in some embodiments, changing the subset of points of each of the plurality of sequences of probe data points identified as the candidate splitting points in the successive mutations on candidate solutions to increase the fitness metric.

The fitness metric of an example embodiment includes a score reflecting one or more of lengths of the bunches of legs, a number of bunches, a number of legs within the bunches, or a distance metric between the legs within a respective bunch of legs. According to some embodiments, grouping legs into bunches of legs includes grouping legs into bunches of legs based on a predefined degree of similarity between the legs, where the predefined degree of similarity includes: starting points within a predefined distance of one another, and ending points within a predefined distance of one another. The predefined degree of similarity of some embodiments further includes trajectories between the starting points and the ending points of a bunch within a predefined Fréchet distance measure.

Embodiments described herein provide an apparatus including: means for receiving a plurality of sequences of probe data points from a plurality of probe apparatuses; means for identifying splitting points in each of the plurality of sequences of probe data points; means for identifying legs of the plurality of sequences of probe data points between pairs of splitting points; means for grouping legs into bunches of legs; means for performing a guided search of a solution space containing the bunches of legs by performing successive mutations on candidate solutions in the solution space to identify a solution satisfying a fitness metric threshold; and means for identifying, from the solution satisfying a fitness metric threshold, a road network.

According to some embodiments, the means for identifying splitting points in each of the plurality of sequences of probe data points includes: means for identifying a starting point of each of the plurality of sequences of probe data points as a fixed splitting point; means for identifying an ending point of each of the plurality of sequences of probe data points as a fixed splitting point; and means for identifying a subset of points of each of the plurality of sequences of probe data points as candidate splitting points. The means for performing the guided search of the solution space containing the bunches of legs by performing successive mutations on candidate solutions in the solution space to identify the solution satisfying the fitness metric includes, in some embodiments, means for changing the subset of points of each of the plurality of sequences of probe data points identified as the candidate splitting points in the successive mutations on candidate solutions to increase the fitness metric.

The fitness metric of an example embodiment includes a score reflecting one or more of lengths of the bunches of legs, a number of bunches, a number of legs within the bunches, or a distance metric between the legs within a respective bunch of legs. According to some embodiments, the means for grouping legs into bunches of legs includes means for grouping legs into bunches of legs based on a predefined degree of similarity between the legs, where the predefined degree of similarity includes: starting points within a predefined distance of one another, and ending points within a predefined distance of one another. The predefined degree of similarity of some embodiments further includes trajectories between the starting points and the ending points of a bunch within a predefined Fréchet distance measure.

Embodiments provided herein include an apparatus including at least one processor and at least one non-transitory memory including computer program code instructions, the computer program code instructions configured to, when executed, cause the apparatus to at least: receive a plurality of trajectories of probe data points from a plurality of probe apparatuses; identify splitting points in each of the plurality of trajectories of probe data points; identify legs of the plurality of trajectories of probe data points between pairs of splitting points of the same trajectory; assign legs into bunches; search a solution space determined by determined by splitting point sections and leg bunch assignments; determine, from the bunches of legs, a selected solution representing a map of a road network; and facilitate at least one of navigational assistance or at least semi-autonomous vehicle control using the map of the road network.

Wherein causing the apparatus of some embodiments to search the solution space includes causing the apparatus to perform a guided search of the solution space containing the bunches of legs by causing the apparatus to perform successive mutations on candidate solutions in the solution space through the addition or removal of one or more splitting points to increase an overall fitness of the candidate solutions; and identify the selected solution of the candidate solutions, where the selected solution has an associated fitness metric. Causing the apparatus of some embodiments to perform successive mutations on candidate solutions in the solution space through the addition or removal of one or more splitting points to increase an overall fitness of the candidate solutions includes causing the apparatus to at least one of add a splitting point within a trajectory or remove a splitting point between two legs in a trajectory.

Causing the apparatus of some embodiments to perform successive mutations on candidate solutions in the solution space through the addition or removal of one or more splitting points to increase the overall fitness of the candidate solutions further includes causing the apparatus to change a bunch assignment of one or more legs. Causing the apparatus to identify the selected solution of the candidate solutions having an associated fitness metric includes causing the apparatus to identify the selected solution of the candidate solutions having a fitness metric satisfying a predetermined threshold. The fitness metric of some embodiments includes a score reflecting one or more lengths of the bunches of legs, a number of bunches, a number of legs within the bunches, or a distance metric function between legs within a respective bunch of legs. Causing the apparatus of some embodiments to determine, from the bunches of legs and splitting points, the selected solution representing the map of the road network includes causing the apparatus to determine the map of the road network without relying on underlying map data of an existing road network.

Embodiments provided herein include a computer program product including at least one non-transitory computer-readable storage medium having computer-executable program code instructions stored therein, the computer-executable program code instructions including program code instructions to: receive a plurality of trajectories of probe data points from a plurality of probe apparatuses; identify splitting points in each of the plurality of trajectories of probe data points; identify legs of the plurality of trajectories of probe data points between pairs of splitting points; assign legs into bunches of legs; search a solution space determined by splitting point sections and leg bunch assignments; determine, from the bunches of legs, a selected solution representing a map of a road network; and facilitate at least one of navigational assistance or at least semi-autonomous vehicle control using the map of the road network.

The program code instructions to search the solution space determined by splitting point and leg bunch assignments include, in some embodiments, program code instructions to: perform a guided search of the solution space containing the bunches of legs by performing successive mutations on candidate solutions in the solution space through the addition or removal of one or more splitting points to increase an overall fitness of the candidate solutions; and identify the selected solution of the candidate solutions, where the selected solution has an associated fitness metric. The program code instructions to perform successive mutations on candidate solutions in the solution space through the addition or removal of one or more splitting points to increase an overall fitness of the candidate solution includes, in some embodiments, program code instructions to at least one of add a splitting point within a trajectory or remove a splitting point between two legs of a trajectory.

The program code instructions to perform successive mutations on candidate solutions in the solution space through the addition or removal of one or more splitting points to increase an overall fitness of the candidate solutions include, in some embodiments, program code instructions to change a bunch assignment of one or more legs. The program code instructions to identify the selected solution of the candidate solutions having an associated fitness metric include, in some embodiments, program code instructions to identify the selected solution of the candidate solutions having a fitness metric satisfying a predetermined threshold. The fitness metric includes, in some embodiments, a score reflecting one or more of: lengths of the bunches of legs, a number of bunches, a number of legs within the bunches, or a distance metric between legs within a respective bunch of legs. The program code instructions to determine, from the bunches of legs, the selected solution representing the map of the road network includes, in some embodiments, program code instructions to determine the map of the road network without relying on underlying map data of an existing road network.

Embodiments provided herein include a method including: receiving a plurality of trajectories of probe data points from a plurality of probe apparatuses; identifying splitting points in each of the plurality of trajectories of probe data points; identifying legs of the plurality of trajectories of probe data points between pairs of splitting points; assigning legs into bunches of legs; searching a solution space determined by leg bunch assignments; determining, from the bunches of legs, a selected solution representing a map of a road network; and facilitating at least one of navigational assistance or at least semi-autonomous vehicle control using the map of the road network. Searching the solution space determined by splitting point sections and leg bunch assignments includes, in some embodiments: performing a guided search of the solution space containing the bunches of legs by performing successive mutations on candidate solutions in the solution space through the addition or removal of one or more splitting points to increase an overall fitness of the candidate solutions; and identifying the selected solution of the candidate solutions, where the selected solution has an associated fitness metric.

According to some embodiments, performing successive mutations on candidate solutions in the solution space through the addition or removal of one or more splitting points to increase an overall fitness of the candidate solution includes: at least one of adding a splitting point within a trajectory or removing a splitting point between two legs in a trajectory. Performing successive mutations on candidate solutions in the solution space through the addition or removal of one or more splitting points to increase an overall fitness of the candidate solutions includes, in some embodiments, changing a bunch assignment of one or more legs. According to some embodiments, identifying the selected solution of the candidate solutions having an associated fitness metric includes identifying the selected solution of the candidate solutions having a fitness metric satisfying a predetermined threshold. The fitness metric of some embodiments includes a score reflecting one or more lengths of the bunches of legs, a number of bunches, a number of legs within the bunches, or a distance metric between legs within a respective bunch of legs.

Embodiments provided herein include an apparatus including: means for receiving a plurality of trajectories of probe data points from a plurality of probe apparatuses; means for identifying splitting points in each of the plurality of trajectories of probe data points; means for identifying legs of the plurality of trajectories of probe data points between pairs of splitting points; assigning legs into bunches of legs; means for searching a solution space determined by leg bunch assignments; means for determining, from the bunches of legs, a selected solution representing a map of a road network; and means for facilitating at least one of navigational assistance or at least semi-autonomous vehicle control using the map of the road network. The means for searching the solution space determined by splitting point sections and leg bunch assignments includes, in some embodiments: means for performing a guided search of the solution space containing the bunches of legs by performing successive mutations on candidate solutions in the solution space through the addition or removal of one or more splitting points to increase an overall fitness of the candidate solutions; and means for identifying the selected solution of the candidate solutions, where the selected solution has an associated fitness metric.

According to some embodiments, the means for performing successive mutations on candidate solutions in the solution space through the addition or removal of one or more splitting points to increase an overall fitness of the candidate solution includes: at least one of means for adding a splitting point within a trajectory or means for removing a splitting point between two legs in a trajectory. The means for performing successive mutations on candidate solutions in the solution space through the addition or removal of one or more splitting points to increase an overall fitness of the candidate solutions includes, in some embodiments, means for changing a bunch assignment of one or more legs. According to some embodiments, the means for identifying the selected solution of the candidate solutions having an associated fitness metric includes means for identifying the selected solution of the candidate solutions having a fitness metric satisfying a predetermined threshold. The fitness metric of some embodiments includes a score reflecting one or more lengths of the bunches of legs, a number of bunches, a number of legs within the bunches, or a distance metric between legs within a respective bunch of legs.

Embodiments provided herein include an apparatus including at least one processor and at least one non-transitory memory including computer program instructions stored therein, the computer program code instructions configured to, when executed, cause the apparatus to at least: receive a plurality of sequences of probe data points from a plurality of probe apparatuses; identify splitting points in each of the plurality of sequences or probe data points, where the splitting points represent points where a respective sequence of probe data points is split and decomposed into a plurality of legs; identify the plurality of legs of the plurality of sequences of probe data points between pairs of splitting points; group legs of the plurality of legs according to a hierarchical optimizer into bunches of legs; determine, from the bunches of legs, a map representation of a road network; compose bunches of legs into a directed graph based on leg continuations, where the directed graph is formed by bunches connected to continuation bunches of legs, and graph nodes of the directed graph represent intersection decision points; and simulate a condition including traffic flow within the road network based on decisions made at the intersection decision points.

According to some embodiments, decisions made at the intersection decision points are determined based on information associated with the condition. The condition of an example embodiment includes an event impacting traffic volumes and a direction of traffic flow. Causing the apparatus of some embodiments to determine, from the bunches of legs, the map representation of the road network includes causing the apparatus to: perform a guided search of a solution space containing the bunches of legs by causing the apparatus to perform successive mutations on candidate solutions in the solution space; determine, for the candidate solutions, numbers of splitting points and lengths of bunches of legs of a respective candidate solution; identify a solution of the candidate solutions, where the identified solution includes a higher fitness value than other candidate solutions, and where the identified solution defines the map representation of the road network formed by the directed graph formed by the bunches of legs.

According to some embodiments, causing the apparatus to perform successive mutations on the candidate solutions in the solution space includes causing the apparatus to at least one of add a splitting point within a bunch of legs or remove a splitting point between two bunches of legs. Causing the apparatus of some embodiments to identify the solution of the candidate solutions includes causing the apparatus to identify the solution of the candidate solutions having a fitness metric that satisfies a fitness metric threshold. The fitness metric of an example embodiment includes a score reflecting one or more of lengths of the bunches of legs, a number of bunches, a number of legs within the bunches, or a distance metric between the legs within a respective bunch of legs. Causing the apparatus of some embodiments to simulate a condition including traffic flow within the road network based on decisions made at the intersection decision points includes causing the apparatus to: predict traffic volumes for road segments of the map representation of the road network; and predict decisions at intersection decision points within the map representation of the road network.

Embodiments provided herein include a computer program product having at least one non-transitory computer-readable storage medium having computer-executable program code instructions stored therein, the computer-executable program code instructions including program code instructions to: receive a plurality of sequences of probe data points from a plurality of probe apparatuses; identify splitting points in each of the plurality of sequences or probe data points, where the splitting points represent points where a respective sequence of probe data points is split and decomposed into a plurality of legs; identify the plurality of legs of the plurality of sequences of probe data points between pairs of splitting points; group legs of the plurality of legs according to a hierarchical optimizer into bunches of legs; determine, from the bunches of legs, a map representation of a road network; compose bunches of legs into a directed graph based on leg continuations, where the directed graph is formed by bunches of legs connected to continuation bunches of legs and graph nodes of the directed graph represent intersection decision points; and simulate a condition including traffic flow within the road network based on decisions made at the intersection decision points.

According to some embodiments, decisions made at the intersection decision points are determined based on information associated with the condition. The condition of some embodiments includes an event impacting traffic volumes and a direction of traffic flow. The program code instructions to determine, from the bunches of legs, the map representation of the road network includes program code instructions to: perform a guided search of a solution space containing the bunches of legs by causing the apparatus to perform successive mutations on candidate solutions in the solution space; determine, for the candidate solutions, numbers of splitting points and lengths of bunches of legs of a respective candidate solution; and identify a solution of the candidate solutions, where the identified solution includes a higher fitness value than other candidate solutions, and where the identified solution defines the map representation of the road network formed by the directed graph of the bunches of legs.

The program code instructions to perform successive mutations on the candidate solutions in the solution space include, in some embodiments, program code instructions to at least one of add a splitting point within a bunch of legs or remove a splitting point between two bunches of legs. The program code instructions to identify the solution of the candidate solutions include program code instructions to identify the solution of the candidate solutions having a fitness metric that satisfies a fitness metric threshold. The fitness metric of some embodiments includes a score reflecting one or more of lengths of the bunches of legs, a number of bunches, a number of legs within the bunches, or a distance metric between the legs within a respective bunch of legs. The program code instructions to simulate a condition including traffic flow within the road network based on decisions made at the intersection decision points include, in some embodiments, program code instructions to: predict traffic volumes for road segments of the map representation of the road network; and predict decisions at intersection decision points within the map representation of the road network.

Embodiments provided herein include a method including: receiving a plurality of sequences of probe data points from a plurality of probe apparatuses; identifying splitting points in each of the plurality of sequences of probe data points, where the splitting points represent points where a respective sequence of probe data points is split and decomposed into a plurality of legs; identifying the plurality of legs of the plurality of sequences of probe data points between pairs of splitting points; grouping legs of the plurality of legs according to a hierarchical optimizer into bunches of legs; determining, from the bunches of legs, a map representation of a road network; composing bunches of legs into a directed graph based on leg continuations, where the directed graph is formed by bunches of legs connected to continuation bunches of legs, and graph nodes of the directed graph represent intersection decision points; and simulating a condition including traffic flow within the road network based on decisions made at the intersection decision points.

According to some embodiments, decisions made at the intersection decision points are determined based on information associated with the condition. Determining, from the bunches of legs, the map representation of the road network includes, in some embodiments: performing a guided search of a solution space containing the bunches of legs by causing the apparatus to perform successive mutations on candidate solutions in the solution space; determining, for the candidate solutions, numbers of splitting points and lengths of bunches of legs of a respective candidate solution; and identifying a solution of the candidate solutions, where the identified solution includes a higher fitness value than other candidate solutions, and where the identified solution defines the map representation of the road network formed by the directed graph of the bunches of legs. Simulating a condition including traffic flow within the road network based on decisions made at the intersection decision points include: predicting traffic volumes for road segments of the map representation of the road network; and predicting decision at intersection decision points within the map representation of the road network.

Embodiments provided herein include an apparatus including: means for receiving a plurality of sequences of probe data points from a plurality of probe apparatuses; means for identifying splitting points in each of the plurality of sequences of probe data points, where the splitting points represent points where a respective sequence of probe data points is split and decomposed into a plurality of legs; means for identifying the plurality of legs of the plurality of sequences of probe data points between pairs of splitting points; means for grouping legs of the plurality of legs according to a hierarchical optimizer into bunches of legs; means for determining, from the bunches of legs, a map representation of a road network; means for composing bunches of legs into a directed graph based on leg continuations, where the directed graph is formed by bunches of legs connected to continuation bunches of legs, and graph nodes of the directed graph represent intersection decision points; and means for simulating a condition including traffic flow within the road network based on decisions made at the intersection decision points.

According to some embodiments, decisions made at the intersection decision points are determined based on information associated with the condition. The means for determining, from the bunches of legs, the map representation of the road network includes, in some embodiments: means for performing a guided search of a solution space containing the bunches of legs by causing the apparatus to perform successive mutations on candidate solutions in the solution space; means for determining, for the candidate solutions, numbers of splitting points and lengths of bunches of legs of a respective candidate solution; and means for identifying a solution of the candidate solutions, where the identified solution includes a higher fitness value than other candidate solutions, and where the identified solution defines the map representation of the road network formed by the directed graph of the bunches of legs. The means for simulating a condition including traffic flow within the road network based on decisions made at the intersection decision points include: means for predicting traffic volumes for road segments of the map representation of the road network; and means for predicting decision at intersection decision points within the map representation of the road network.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for the generation of structured trajectories from geospatial observations according to an example embodiment of the present disclosure;

FIG. 3 illustrates a plurality of sequences of probe data points within an environment according to an example embodiment of the present disclosure;

FIG. 4 illustrates legs and splitting points formed from the plurality of sequences of probe data points of FIG. 3 according to an example embodiment of the present disclosure;

FIG. 5 illustrates traffic volume weighted legs and splitting points formed from the plurality of sequences of probe data points of FIG. 3 according to an example embodiment of the present disclosure;

FIG. 6 illustrates a basic example embodiment in which three individual trajectories are optimized and split into four interconnected bunches according to an example embodiment of the present disclosure;

FIG. 7 is a flowchart of operations for generation of structured trajectories based on probe data while maintaining privacy and user information according to an example embodiment of the present disclosure;

FIG. 8 is a flowchart of a method for automatic generation of a map of a road network based on the generation of structured trajectories from probe data; and

FIG. 9 is a flowchart of a method for simulating traffic within a road network generated from structured trajectories.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present invention for the generation of structured trajectories from geospatial observations, and more particularly, to the generation of structured trajectories based on probe data while maintaining privacy and user information. Further, embodiments of the structured trajectories are made available for provision of location-based services. Embodiments are configured to use mobility data to generate realistic and plausible position trajectories that represent the true world, but that don't necessarily correspond to any specific user from which the mobility data came. Embodiments do not require existing map infrastructure; however, embodiments can be used to the benefit of existing map infrastructure in some use cases.

Realistic and plausible position trajectories can be used in a variety of use cases. One such use case includes location-based services. Location-based services benefit from data collected from users in an area; however, user location information can be privacy sensitive, whereby individual users do not want their specific locations and paths shared. The desire of users to have valuable, location-based services while also expecting a degree of anonymity are at odds. However, embodiments described herein provide a method that uses mobility data from geospatial observations to generate structured trajectories that can facilitate location-based services while maintaining anonymity of individual user locations and trajectories.

Mobility data may be defined as a set of geospatial observations or probe data points, each of which includes at least a latitude, longitude, and timestamp. Additional information may be associated with the probe data points, such as speed, heading, or other data. A trajectory includes a set of probe data points, where probe data points of a trajectory may include a trajectory identifier that associates the probe data points of the trajectory with one another. Mobility data captured in trajectories can be partitioned in a set of trajectories (trajectory data), each of which identifies the movement of a user over time. Anonymization of trajectories while providing sufficient information for location based services and other use cases for trajectories requires a balance to be struck between valuable trajectory information including location information of probe data points while also introducing ambiguity for anonymization.

A method, apparatus, and computer program product are provided herein in accordance with an example embodiment for generating structured trajectories based on probe data while maintaining privacy and user information. The anonymized, structured trajectories are then used, in an example embodiment, for provision of location-based services. Trajectories for a vehicle and/or mobile device can facilitate the use of location-based services for a variety of functions. However, trajectories themselves may provide substantial information regarding an origin, destination, and path taken by a user associated with a vehicle or mobile device raising privacy concerns. Location-based services rely on accurate location information to provide the most accurate and relevant service. Location-based services are useful to a variety of consumers who may employ location-based services for a wide range of activities. Services such as the identification of traffic location and density, providing information regarding goods and services available in a specific location, and identifying a target group of consumers in a particular location or who travel along a particular path, are among many other location-based services.

While location-based services are desirable for both consumers and for service providers, consumers are often concerned with the amount of information shared about their routines and activities. Thus, while consumers and service providers want to engage with location-based services, consumers generally desire to maintain some degree of privacy. Embodiments described herein provide a method, apparatus, and computer program product through which location information and more specifically, trajectory information can be gathered and shared in a manner that anonymizes the source of the information and makes unmasking of the source difficult. Embodiments provided herein include a data structure and optimization methods for generating the data structure to produce structured trajectories from geospatial observations. These structured trajectories can be used for location-based services in a manner that maintains the privacy of users providing mobility data. Embodiments thereby render it difficult to establish to whom the trajectory belongs while obtaining useful location-based trajectory information for use with location-based services.

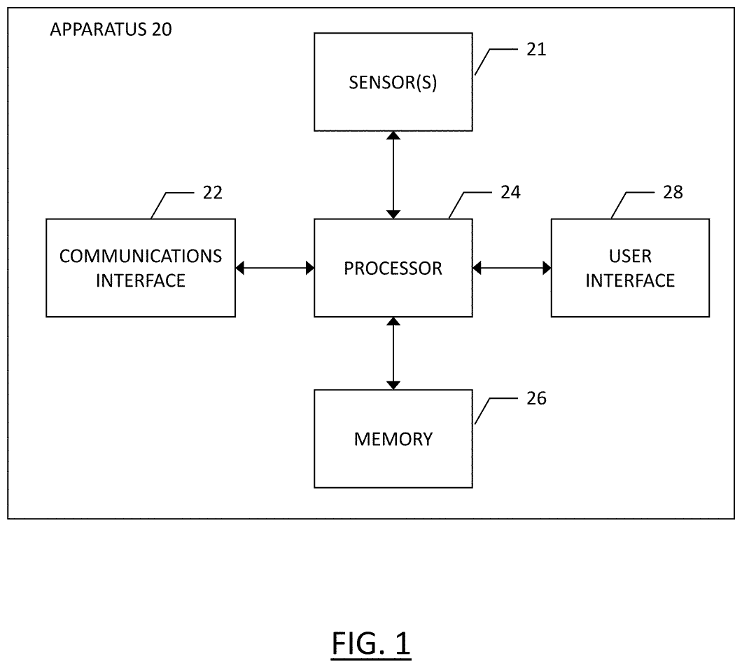

FIG. 1 is a schematic diagram of an example apparatus configured for performing any of the operations described herein. Apparatus 20 is an example embodiment that may be embodied by or associated with any of a variety of computing devices, such as those that include or are otherwise associated with a device configured for providing advanced driver assistance features which may include a navigation system user interface. For example, the computing device may be an Advanced Driver Assistance System module (ADAS) which may at least partially control autonomous or semi-autonomous features of a vehicle. However, as embodiments described herein may optionally be used for map generation, map updating, and map accuracy confirmation, embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. According to an example embodiment where some level of vehicle autonomy is involved, the apparatus 20 is embodied or partially embodied by an electronic control unit of a vehicle that supports safety-critical systems such as the powertrain (engine, transmission, electric drive motors, etc.), steering (e.g., steering assist or steer-by-wire), and braking (e.g., brake assist or brake-by-wire). Optionally, the computing device may be a fixed computing device, such as a built-in vehicular navigation device, assisted driving device, or the like.

Optionally, the apparatus of an example embodiment is embodied by or associated with a plurality of computing devices that are in communication with or otherwise networked with one another such that the various functions performed by the apparatus may be divided between the plurality of computing devices that operate in collaboration with one another.

The apparatus 20 may be equipped or associated, e.g., in communication, with any number of sensors 21, such as a global positioning system (GPS), accelerometer, an image sensor, LiDAR, radar, and/or gyroscope. Any of the sensors may be used to sense information regarding the movement, positioning, or orientation of the device for use in navigation assistance, as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, a processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 24, and/or the like).

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication and/or may alternatively support vehicle to vehicle or vehicle to infrastructure wireless links.

The apparatus 20 may support a mapping or navigation application so as to present maps or otherwise provide navigation or driver assistance. For example, the apparatus 20 may provide for display of a map and/or instructions for following a route within a network of roads via user interface 28. In order to support a mapping application, the computing device may include or otherwise be in communication with a geographic database, such as may be stored in memory 26. For example, the geographic database includes node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LiDAR, ultrasonic and/or infrared sensors.

In example embodiments, a navigation system user interface may be provided to provide driver assistance to a user traveling along a network of roadways. Location-based services such as traffic density, real-time routing based on travel times, event identification for events that may impact travel (e.g., vehicle accidents, sporting events, festivals, etc.), etc. Optionally, embodiments described herein may provide assistance for autonomous or semi-autonomous vehicle control. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control, to lane-keep assist, or the like. Identifying traffic and events along road segments or road links that a vehicle may traverse may provide information useful to navigation and autonomous or semi-autonomous vehicle control by establishing where traffic is present, where pedestrian traffic may be increased, where emergency vehicles are located, etc.

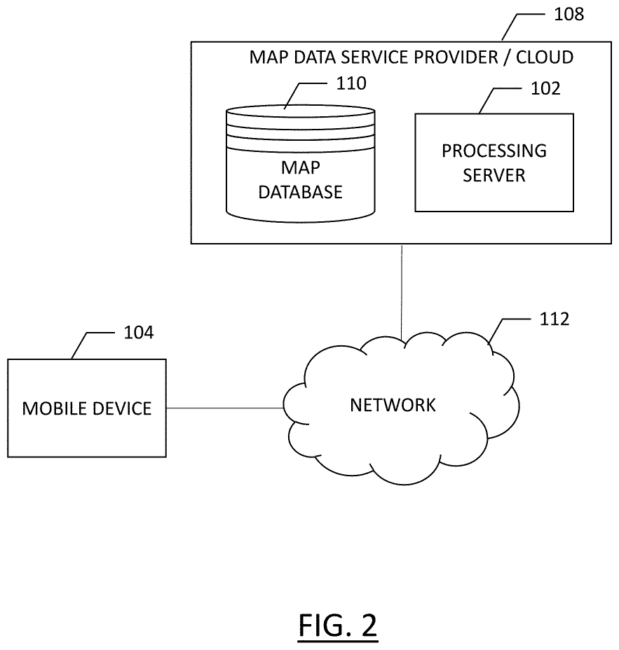

A map service provider database may be used to provide driver assistance via a navigation system and/or through an ADAS having autonomous or semi-autonomous vehicle control features. FIG. 2 illustrates a communication diagram of an example embodiment of a system for implementing example embodiments described herein. The illustrated embodiment of FIG. 2 includes a mobile device 104, which may be, for example, the apparatus 20 of FIG. 2, such as a mobile phone, an in-vehicle navigation system, an ADAS, or the like, and a map data service provider or cloud service 108. Each of the mobile device 104 and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The map data service provider may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device 104, as they travel the roads throughout a region.

The map database 110 may be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map data service provider 108 map database 110 may be a master geographic database, but in alternate or complementary embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

While example embodiments describe herein a map data service provider 108 including a map database 110, embodiments can be employed without requiring a map database 110 as the structured trajectories generated by example embodiments are map data agnostic and rely upon analysis of a plurality of trajectories to establish paths within an environment. An example embodiment described herein does not require reliance on an underlying map and does not require map matching. Example embodiments further do not require constructing a map dynamically during the data structure generation and are optionally temporally agnostic.

In one embodiment, as noted above, the end user device or mobile device 104 can be embodied by the apparatus 20 of FIG. 1 and can include an Advanced Driver Assistance System (ADAS) which may include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of useful driver assistance information, according to some example embodiments.

The map database 110 of example embodiments may be generated from a plurality of different sources of data. For example, municipalities or transportation departments may provide map data relating to roadways, while geographic information survey systems may provide information regarding property and ownership of property within a geographic region. The map database 110, according to an example embodiment, is constructed and/or healed using the structured trajectories generated by the methods described herein. Further, data may be received identifying businesses at property locations and information related to the businesses such as hours of operation, services or products provided, contact information for the business, etc. Additional data may be stored in the map database such as traffic information, routing information, etc. This data may supplement the HD map data that provides an accurate depiction of a network of roads in the geographic region in a high level of detail including road geometries, features along the roads such as signs, etc. The data stored in the map database may be gathered from multiple different sources, and one source of data that may help keep the data in the map database fresh is map data provided by vehicles traveling along the road segments of the road network.

Map data may not be available or may not be reliable for certain regions, such that the available map data may not be of sufficient quality to use for various applications. Further, map data may be useful in some instances only when mobility data or a trajectory is map-matched to the map data, which can be time consuming and processing intensive. Embodiments described herein use mobility data to generate structured trajectories without requiring underlying map data and without requiring map matching. While underlying map data and map matching can be used together with the disclosed structured trajectories, the embodiments described herein do not require map data and map matching to generate the structured trajectories.

Embodiments described herein provide a method to generate realistic and plausible position trajectories that represent the true world, but do not necessarily correspond to any specific users. Embodiments use a data model to create vehicular mix zones efficiently and automatically. For reinforcement learning, realistic trajectories described herein include decision points along the trajectories to choose alternative continuations. Individual trajectories do not offer such decision points. While underlying map data can be used with map-matched trajectories to create segments and to identify continuation alternatives, reliance on existing map data is not always feasible. For automatic map generation it is beneficial to have hypotheses of road links between intersections associated with the raw data for which the hypothesis is based on, such that automatic mapping systems can use the raw data to generate a map with connected road links. Further, embodiments described herein can be used for simulation purposes to simulate scenarios for safety, security, disaster analysis, evacuations, and other scenarios using leg continuation options to simulate potential results of changing conditions such as road closures and congestion.

Embodiments described herein define a data structure and optimization methods that can be used to generate that data structure. The resulting data structure can be employed in a variety of use-cases as described above and detailed below. The system of example embodiments described herein is agnostic to any underlying map, does not require map matching, and does not require constructing such a map dynamically during data structure generation. Embodiments are optionally further agnostic on mobility data timestamps that can enhance the suitability for use with data for which a high-degree of privacy is necessary. Embodiments described herein generate the structured trajectories using optimization of split points of trajectories to improve the utility of the structured trajectories across a wide array of use cases.

Trajectories are sequences of geo-positions or probe data point having a location identifier and a trajectory identifier to identify the sequence to which it belongs. Each of these geo-positions or probe data points can be designated as a “splitting point” which designates an end of a “leg” and the start of a new “leg”. Thus, trajectories are a sequence of legs, each consisting of a sequence of probe data points. Some legs across many different trajectories are recognized as similar if they have similar starting points, ending points, and the “leg trajectory” between the starting and ending points are pair-wise similar in terms of some geometry distance measure, such as Fréchet distance. The legs recognized as similar to one another form a “bunch”. The similarity between the starting points and end points may be configurable, and may optionally be influenced by a density of a region. For example, a similarity factor may be more broad in a rural area or an area with a low population density, where legs further apart are considered similar. In a high population density area, a similarity factor may be narrower requiring legs to be relatively close together to be considered similar. Without the understanding of map data such as population density or urban/rural areas, the similarity factor is optionally established based on a density of trajectories in an area. If there are few trajectories, the area may be interpreted as a low population density or less-traveled area where the similarity factor may be more broad. While similarity or proximity of legs to one another is used in some embodiments to group legs into bunches, legs are optionally grouped into bunches based on an optimizer assignment, as described further below.

Where each bunch of legs of trajectories ends, the set of leg trajectory continuations as subsequent legs for each leg in the bunch form alternative options for continuations. A leg that belongs to a bunch, which designates a set of similar legs, where that set of similar legs have trajectory-wise continuations as next legs within their respective trajectories. The set of these next legs form a set of alternative options for tree-like branching continuations of plausible and realistic simulated trajectories.

The formation of bunches of trajectories is the basis for the generation of structured trajectories from mobility (probe) data. The formation of bunches further provides privacy through the aggregation of trajectory legs mitigating the influence of any single trajectory and precluding reidentification of a source of an individual trajectory. However, according to an example embodiment, formation of the bunches as described herein uses an optimization process to efficiently and effectively form the bunches in a reliable manner.

The optimization process beings with an initial condition of zero or more points in a set of trajectories designated as splitting points. By convention, the starting point and ending point of each trajectory are designated as splitting points. As noted above, a single leg lacks any splitting points between the starting point and ending point as it is a single, sequential path of probe data points. It is possible to begin the optimization process with no points chosen as candidate splitting points (other than the fixed splitting points where the trajectories start and end), all points designated as candidate splitting points, or a randomly sampled set of points designated as candidate splitting points. Candidate splitting points are possible splitting points, whereas fixed splitting points of the beginning and ends of trajectories are known splitting points. The optimization process of example embodiments performs a guided search of the solution space by performing sets of successive mutations to the candidate solutions searching for a better solution based on a fitness metric. The mutations are either turning a splitting point into a non-splitting point, or a non-splitting point into a splitting point. Multiple mutations can be combined into a single optimization step.

The optimization process identifies splitting points in each of a plurality of sequences of probe data point, with legs defined between each pair of splitting points in a trajectory. Legs are grouped based on similarity (e.g., proximity of starting and ending splitting points) if a single-level optimization is used. Embodiments optionally employ another optimization, whereby splitting points can be changed iteratively to establish if legs defined between a new set of splitting points are more optimally grouped into bunches. If a grouping fitness metric of legs within bunches is not satisfied for a particular iteration of splitting points, the legs are re-grouped to improve the grouping fitness metric until the grouping fitness metric has occurred.

Each leg belongs to one bunch, which possibly includes other legs. Each of these legs in the bunch have subsequent legs on their respective trajectories. The set of these subsequent legs for all of the legs in one bunch belong to one or more bunches. The set of these “continuation” bunches form the continuations for the first bunch. Hence, the bunches form a directed graph, so that where one bunch ends, zero or more bunches begin. These can form loops, and in principle, form an abstraction of a road map for the region in which the probe data is gathered. Once the grouping fitness metric has converged, and a candidate solution is found for the solution space that satisfies a fitness metric threshold, the candidate solution becomes the output of the optimization. Within this solution, where there are more than one possible bunch continuation, an intersection point is defined for a road map. For the intersection point, embodiments producing a simulation include an agent to choose which of the alternative subsequent bunches to follow as further described below.

The fitness metric is a multi-objective fitness with some subset of the following non-exhaustive list of fitness metrics: minimizing the number of splitting points, maximizing the length of bunches, minimizing the distance metric between legs within the same bunch, minimizing the number of bunches, and maximizing the number of legs within the bunches. The fitness metric of an example embodiment is a score representing the optimization based on the factors described above. The fitness metric of an example embodiment is a relative score based on a number of probe data point sequences of input data, where the “minimizing” of the number of splitting points or bunches is optionally based on a ratio or factor of the total number of probe data point sequences of the input data. The optimization process of an example embodiment seeks to satisfy a fitness metric threshold, above which the solution satisfying the fitness metric threshold is deemed sufficiently optimized to reflect a road network associated with the probe data point sequences. Bunches are recognized for each candidate solution by clustering together similar legs from the set of all legs from all trajectories. The similarity of legs is defined based on a distance measure that compares the starting points, the ending points, and the leg trajectories in between these points.

The optimizer of an example embodiment is decomposed into hierarchical parts. For example: A) the top-level optimizer optimizing for the fitness by modifying the split points; and B) the second level optimizer optimizing the bunch assignments of legs based on the split points from the top-level optimizer candidate solution. Optionally, all of the aforementioned aspects of the solution can be optimized jointly. The optimizers of an example embodiment are locality-sensitive such that they are biased toward mutations applying to the same local region in the same optimization step to improve the optimization performance. Any distance measures, locality-heuristics, and data reference additionally can benefit from spatial indexing such as R-Trees. The optimization can be employed by iteratively making changes to the model parameters in a guided fashion to increase the “fitness” of the results. The fitness value increases as the bunches of legs produce bunches with less distance deviation and closer splitting points. According to an example embodiment, there are two hierarchical optimizers, but optimizing for the same ultimate fitness function. These optimizers can be hierarchical as their iteration cycles are different.

According to an example embodiment, for each full round of splitting point optimization by the optimizer, the bunch assignment optimizer can run multiple rounds, trying in effect different bunch assignments for the legs as in which legs belong to which bunches, that produces the best fitness value. The fitness value from the optimizer loop is the fitness value that the slower, higher level optimizer obtains for optimizing the leg splitting selections. Optimization is performed until a “best” solution is found. The “best” solution may not be an absolute, but a best solution from among hundreds or thousands of possible solutions that are measured. For example, a set of trajectories are gathered and for these trajectories, splitting points are identified. These splitting points may include some or all of the probe data points of each of the trajectories. The legs of the trajectories that are portions of the trajectories between the identified splitting points are then grouped into bunches. A guided search of the bunches of legs are performed by successive mutations on a candidate solution to quantify a fitness metric of the solution. This is performed to identify the best possible grouping of bunches of legs based on the splitting points. If a candidate solution does not satisfy a fitness metric (e.g., a minimum threshold), the grouping can be analyzed to establish if the grouping is the best available. The grouping can be established as the best available if through iterations, a better grouping is not found within a predetermined number of iterations, such as a hundred or a thousand groupings. If the grouping is the best available or if it has ‘converged’, and the solution does not satisfy the fitness metric, a revision is made to the splitting points to identify a better distribution of the splitting points. With the revised splitting points, the grouping optimization is again performed until a solution is found that satisfies the fitness metric.

The optimization strategy produces a robust network of structured trajectories that can be used for a variety of use cases. The minimization of the number of splitting points, for example, ensures that only actual intersection or decision points along a structured trajectory are designated splitting points between bunches. Maximizing the length of bunches also minimizes splitting points as each bunch omits splitting points along its length. Minimizing the distance metric between the legs within the same bunch helps to ensure the trajectory legs are sufficiently similar to be considered within the same bunch. Minimizing the number of bunches optimizes the data in a similar manner as maximizing the length of bunches by ensuring that bunches are as long as possible and as few as possible to efficiently and effectively represent the structured trajectories. Maximizing the number of legs within bunches further improves the quality and reliability of the bunches by each bunch reflecting a greater number of individual trajectory legs.

Linear roads and pathways are well-represented by standard pair-wise multiline distance measures between different legs in optimization. However, in the real world there are also areas of arbitrary mobility with substantially unstructured movement. For example, unstructured parking areas or parking lots do not ideally fit into the above-described data structure. Such areas can be specially handled by an alternative distance metric that compares the entry/exit points from such regions between different trajectories, and how well the leg trajectories in between constrain to a local area of arbitrary mobility, which is defined by the set of legs included into that bunch. In practice, the optimizer loss function of an example embodiment is defined such that the loss for a bunch of legs is computed both for the assumption that this bunch represents an area of arbitrary mobility and for the case that it represents a linear path, and the minimum of these two losses is taken as the loss value for this bunch.

According to some embodiments described herein, trajectories can be pre-processed to improve their quality and to make them conformal and uniformly sampled before using them in the optimized data structure. The quality and heterogeneity of the trajectories of some embodiments require special adaptations in the distance measured used in example embodiments of the optimization process described herein, particularly in relation to being robust to sampling errors and sampling rate variance.

Timestamped probe data points are beneficial for temporally-based use cases of the structured trajectories generated by the methods described herein, such as for predicting traffic congestion, identifying popular paths, determining operating hours for points-of-interest, etc. However, timestamps are not necessary either in an absolute or relative sense. For some basic embodiments described herein, only the trajectory geometries are generated without regard for time based on position sequences of probe data points. For some embodiments, timestamps of probe data is removed to increase a level of privacy. Vehicle speeds, vehicle orientations, and other such data that is optionally included in probe data is used in some embodiments, and is optionally used for determining leg similarity estimation as extra variables.

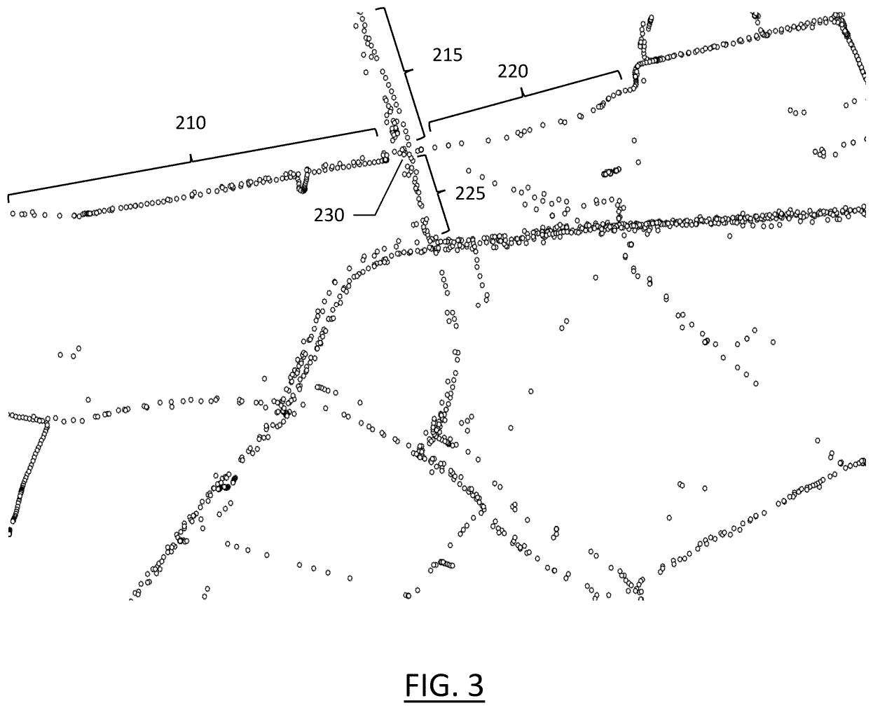

FIG. 3 illustrates a visualization of an example embodiment described herein. As shown, a plurality of probe data points are collected represented by the individual points in the figure. Each sequence of points from a single probe data source defines a trajectory. These trajectories are optionally pre-processed to improve their quality, such as their relative linearity and removing outliers. The trajectories are then processed as described above to generate a sequence of legs from each trajectory, with the splitting points iteratively established to minimize the number of splitting points through the optimization process. The trajectory legs are aggregated into bunches of an optimized, maximized length between established splitting points. FIG. 3 illustrates an example splitting point 230 where trajectory leg 210 splits into trajectory legs 215, 220, and 225. The optimization, according to an example embodiment described above, minimizes the number of bunches, and maximizing the number of trajectory legs within each bunch.

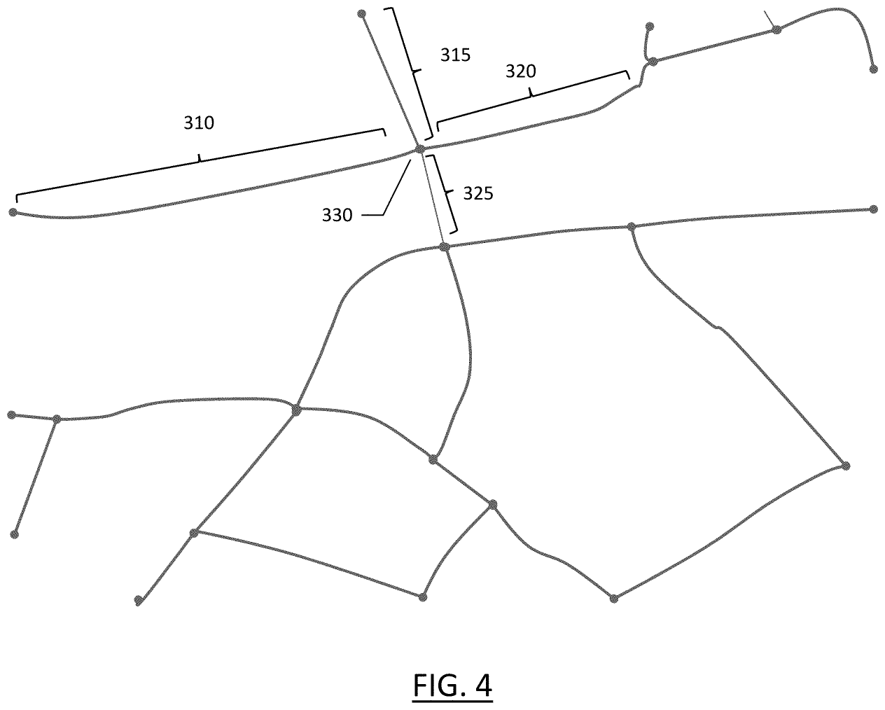

FIG. 4 illustrates the structured trajectories established based on the optimization methods described herein. As shown, the probe data points of trajectory legs 210, 215, 220, and 225 become structured trajectory bunches 310, 315, 320, and 325, respectively. Splitting point 330 is the intersection of these structured trajectory bunches. These structured trajectories illustrate that a base map or road network is not necessary to establish where roads and intersections exist. Further, personal and identifying information of the probe data points of the trajectories of FIG. 3 are unnecessary to generate these structured trajectories.

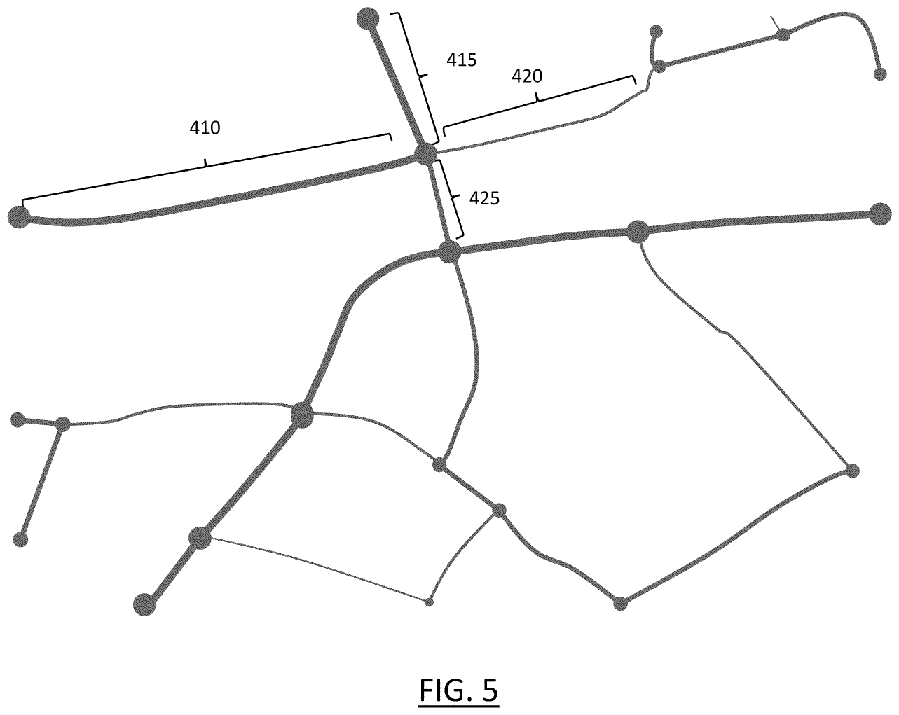

FIG. 5 illustrates a traffic-weighted embodiment of structured trajectories, with line weights or thicknesses representing the volume of traffic on the respective trajectory leg bunch. For example, structured trajectory bunches 410 and 415 are relatively heavily traveled, while structured trajectory bunch 425 is moderately traveled, and structured trajectory bunch 420 is lightly traveled. These traffic volumes are established in an example embodiment based on a number of trajectory legs within each bunch. The greater the number of trajectory legs, the more heavily traveled the respective bunch. The embodiment of FIG. 5 can be aggregated over a long period of time, where the weighted structured trajectory bunches can reflect a likely road class, such as a structured trajectory bunch with the heaviest volume of traffic may be estimated to be a restricted-access expressway, while light volume structured trajectory bunches may be arterial roads.

According to an example embodiment where probe data points are used with timestamps, the weighting of structured trajectory bunches is performed in time windows, such that dynamic traffic volumes are established. Dynamic traffic volumes along the structured trajectories is used for location-based services such as navigation and for aiding autonomous or semi-autonomous vehicle control based on traffic densities. Optionally, dynamic traffic volumes are used to determine volumes at different epochs (times of day, days of week, seasons of year, special events, etc.) to predict traffic volumes at future corresponding or correspondingly similar epochs. Embodiments provided herein facilitate such location-based services while offering a high degree of privacy protection.

Embodiments described herein are able to identify anomalies in vehicle travel that can be useful for navigation or information for a user. For example, structured trajectories can be monitored for anomalies, where anomalies may indicate a large scale event, such as a sporting event, road construction, a vehicle accident, etc. While probe data itself is useful, probe data is typically privacy sensitive. Building legs and bunches as described herein for structured trajectories, and monitoring how these structured trajectories change over time enables dynamic feedback from the structured trajectories. Probe data does not have to be map matched by example embodiments improving efficiency with which probe data can be processed, and since the probe data is aggregated, privacy issues are mitigated. Legs and bunches of an example embodiment are continuously updated, and static or historical legs and bunches can be used to compare against new legs and bunches to identify anomalies. A difference in statistical distribution with respect to new trajectory data is used by an example embodiment to determine if traffic congestion is building such that a user may be routed around such an event.

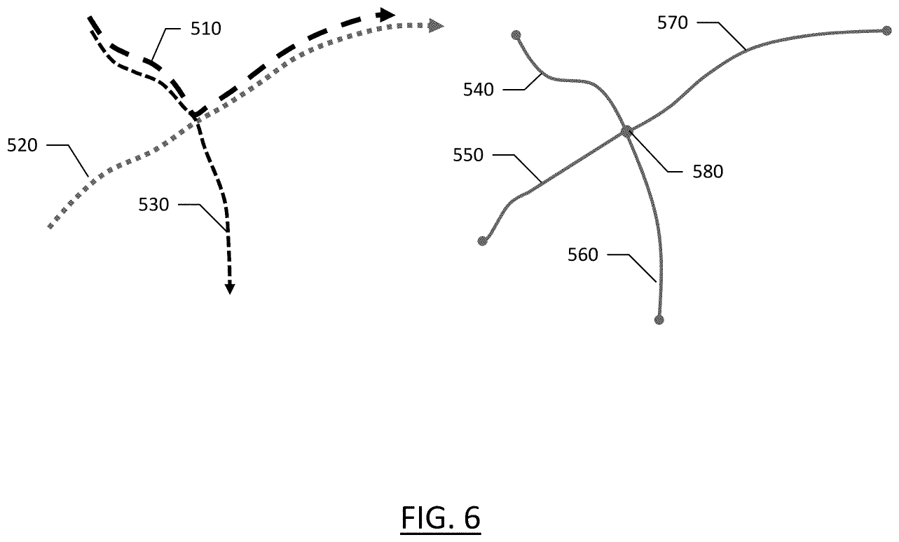

FIG. 6 illustrates a basic example embodiment in which three individual trajectories (510, 520, and 530) are optimized and split into four interconnected bunches (540, 550, 560, and 570). These four interconnected bunches with split point 580 as the intersection. These four interconnected bunches include, in the example embodiment, six legs, where trajectory 510 includes a leg of bunch 540 and 470, trajectory 520 includes a leg of bunch 550 and 570, and trajectory 530 includes a leg of bunch 540 and 560. The embodiment of FIG. 6 is a simplified embodiment for ease of understanding, as bunches generally are not limited to a single trajectory leg.

The privacy of individuals associated with probe apparatuses such as mobile devices or vehicles is maintained through the generation of plausible and realistic full trajectories by random sampling continuation options of successive legs. The resultant simulated trajectory does not correspond to any specific user, vehicle, or data source. Reinforcement learning is provided by enabling a learning agent to choose leg continuations in a simulation where the agent attempts to optimize some objective, such as route speed to a destination.

Embodiments provided herein facilitate automated mapping, where each bunch forms a candidate road segment, and the raw data within that bunch is available for a separate inferential system that is able to trace the raw data behind a generated road segment to a set of individual trajectory legs which define that road link segment. The continuations of bunches to the bunches associated to the subsequent leg continuation options form candidates for connected subsequent road link segments. As is evident in the embodiments of FIGS. 3-6, the structured trajectories of example embodiments provided herein produce robust road network maps without requiring underlying map data. Further, according to example embodiments employed with existing map data, embodiments provide road map healing, building, and updating using the structured trajectories to build and revise map data based on where travel actually occurs.

Advantageously, embodiments using structured trajectory data described herein can be employed to generate map information for mapping roads in a geographic area. While map data may be available for a region, embodiments do not require underlying map data to generate road maps as described herein. The generation of maps with structured trajectories can identify issues in underlying map data, such as inaccuracies in road segment location, road segment information (e.g., number of lanes, heading, etc.). The generation of maps using structured trajectories can be used without any prior knowledge of a region to facilitate navigational assistance for a vehicle among the road network, or at least semi-autonomous control of a vehicle through the road network.

Embodiments of the present disclosure optionally provide for simulation, such as related to safety, security, disaster scenario, traffic planning, etc. Embodiments employ the leg continuation options to simulate potential results of changing conditions, such as road closures, traffic issues, or other factors that can influence the travel patterns of individuals. In such embodiments, it is possible to use discrete event simulation or agent-based simulation where the events are triggered by objects or agents reaching leg ending points as decision points, where the simulator system can present available alternatives from the leg continuation options to gents which can then make decisions on which options to choose. These options can be filtered and modified accordingly based on simulated environmental conditions.

Simulation using the structured trajectories described herein can employ a machine learning process by which traffic flow and traffic volumes can be predicted based on learned information. For example, through structured trajectory data from past epochs, understanding destinations associated with trajectories can inform how trajectories will behave when a condition is introduced, such as a road closure, a special event leading to heavy traffic (e.g., a sporting event, an evacuation scenario, weather, etc.). Simulation can be performed using multiple scenarios simultaneously to identify challenges within the road network established through the structured trajectories. Further, simulations can be employed for strategic planning of road closures. During special events, certain road closures may improve traffic flow by reducing choke points in traffic, thereby improving free-flowing traffic. Such simulations can be used to plan for special events, emergency scenarios, and the like.

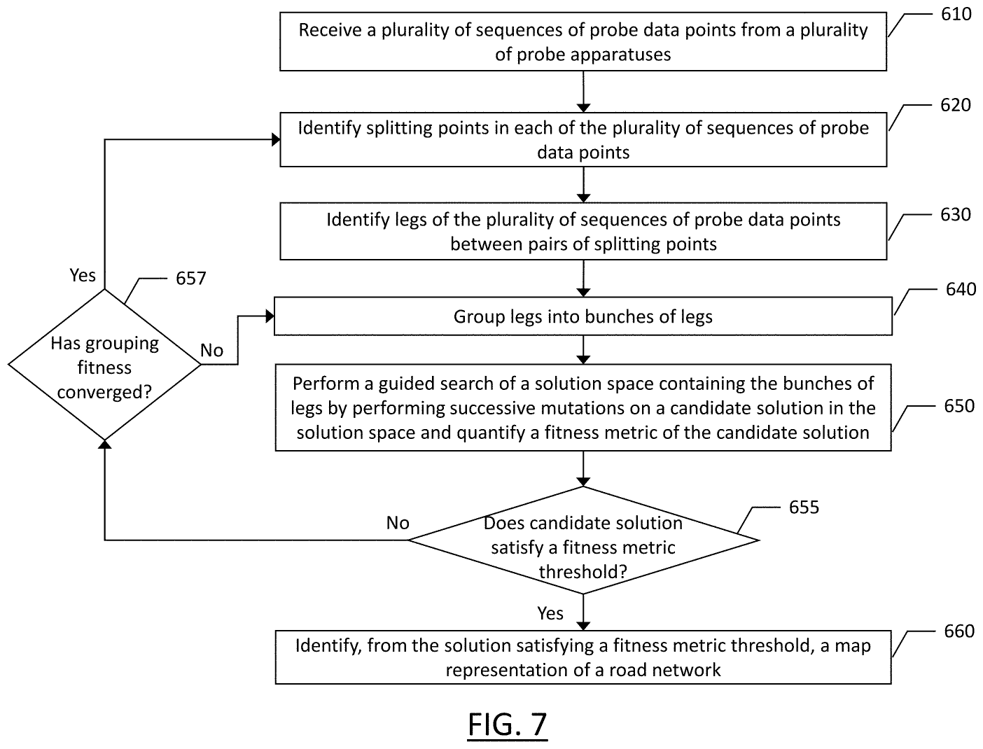

FIGS. 7, 8, and 9 illustrate a flowcharts depicting methods according to example embodiments of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 7 is a flowchart of a method for generating structured trajectories based on probe data while maintaining privacy and user information. According to the illustrated embodiment, a plurality of sequences of probe data point are received from a plurality of probe apparatuses at 610. These probe apparatuses include, for example, vehicles traveling along roadways within a road network, or mobile devices carried by users or vehicles within a road network. Splitting points are identified at 620 in each of the plurality of sequences of probe data points. Legs of the plurality of sequences of probe data points are identified at 630 between pairs of splitting points. Legs are grouped based on a predefined degree of similarity into bunches of legs at 640. A guided search of a solutions space containing the bunches of legs is performed at 650 by performing successive mutations on a candidate solution in the solution space to identify a solution satisfying a fitness metric threshold. This process attempts to identify the candidate solution with the best possible grouping according to the splitting points that are identified in 620.

If the candidate solution does not satisfy a fitness metric threshold at 655, the process establishes at 657 if the grouping of legs into bunches has a fitness that has converged. Convergence of the fitness of bunches of legs can be established in several ways. One embodiment of convergence includes where the fitness metric fails to improve over a particular grouping through a predefined number of additional iterations, such as 1,000. If the grouping fitness has not converged at 657, then legs are grouped again into bunches of legs at 640 and the process continues. If the grouping fitness has converged at 657, the splitting points are iteratively modified and the legs of the modified splitting points are grouped into the bunches to optimize the splitting points and bunches to eventually satisfy the fitness metric threshold. Once the candidate solution satisfies the fitness metric threshold, a road network is identified at 660 from the solution satisfying the fitness metric threshold.

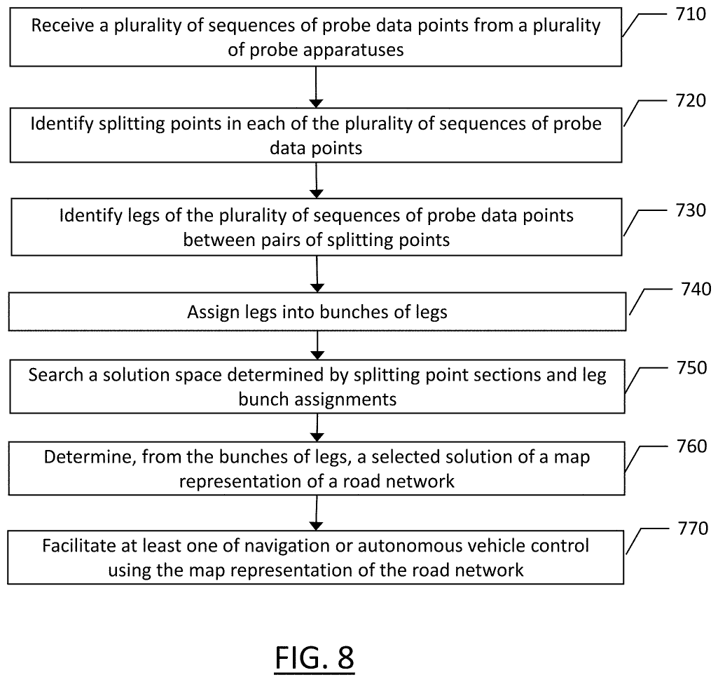

FIG. 8 is a flowchart of a method for automatic generation of a map of a road network based on the generation of structured trajectories from probe data. A plurality of sequences of probe data points are received at 710 from a plurality of probe apparatuses. These probe apparatuses can include, for example, vehicles traveling within a road network. Splitting points are identified at 720 in each of the plurality of sequences of probe data points. Legs of the plurality of sequences of probe data points are identified at 730 between pairs of splitting points. The legs that are within a predefined degree of similarity are grouped at 740 into bunches of legs. One or more of the splitting points are eliminated to increase the length of at least one bunch at 750. From the bunches of legs and splitting points, a map of a road network is determined at 760. Using the map of the road network, at least one of navigational assistance or autonomous vehicle control is facilitated at 770. This may be in the form of providing directions to a driver, activating a vehicle feature based on the map of the road network (e.g., activating traction control on a twisty road), providing at least semi-autonomous control of the vehicle (e.g., automatic braking, changing a transmission shift pattern, steering the vehicle to follow a particular path, etc.).

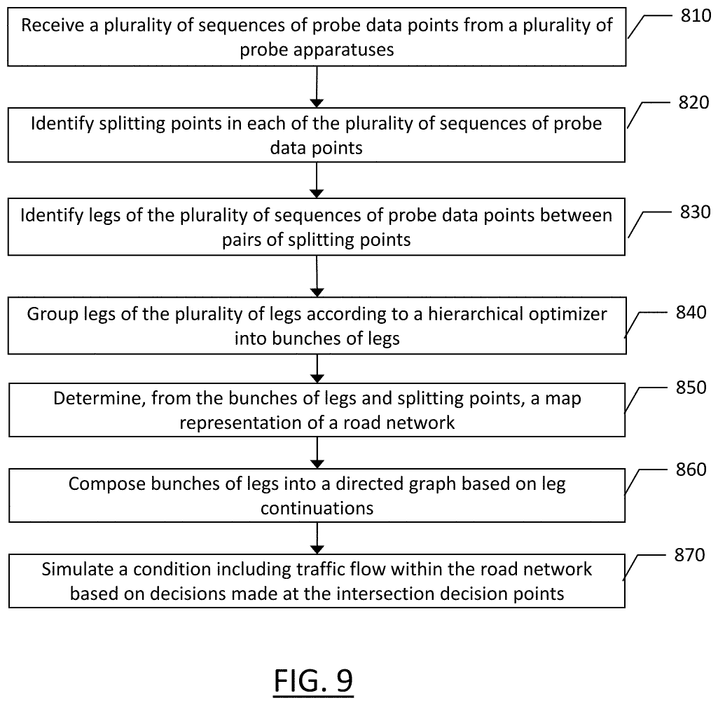

FIG. 9 is a flowchart of a method for simulating traffic within a road network generated from structured trajectories. As shown in FIG. 9, a plurality of sequences of probe data points are received at 810 from a plurality of probe apparatuses. These probe apparatuses can include, for example, vehicles traveling within a road network. Splitting points are identified in each of the plurality of sequences of probe data points at 820. Legs of the plurality of sequences of probe data points are identified at 830 between pairs of splitting points. Legs are grouped when they are within a predefined degree of similarity as illustrated at 840. The predefined degree of similarity may include starting splitting points and/or ending splitting points that are within a predetermined distance of one another, and a heading defined between the splitting points of the legs are within a predefined angle of one another, for example. Based on the bunches of legs and splitting points, a map of a road network is determined at 850. At 860, a condition is simulated including traffic flow within the road network based on decisions made at the intersection decision points.

In an example embodiment, an apparatus for performing the method of FIG. 7 above may comprise a processor (e.g., the processor 24) configured to perform some or each of the operations (610-660, 710-770, and/or 810-860) described above. The processor may, for example, be configured to perform the operations (610-660, 710-770, and/or 810-860) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 610-660, 710-770, and/or 810-860 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one non-transitory memory including computer program code instructions, the computer program code instructions configured to, when executed, cause the apparatus to at least:
receive a plurality of trajectories of probe data points from a plurality of probe apparatuses;
identify splitting points in each of the plurality of trajectories of probe data points;
identify legs of the plurality of trajectories of probe data points between pairs of splitting points;
assign legs into bunches of legs;
search a solution space determined by splitting point sections and leg bunch assignments;
determine, from the bunches of legs, a selected solution of a map representation of a road network; and
facilitate at least one of navigational assistance or at least semi-autonomous vehicle control using the map representation of the road network.

2. The apparatus of claim 1, wherein causing the apparatus to search the solution space determined by splitting point sections and leg bunch assignments comprises causing the apparatus to:
perform a guided search of the solution space containing the bunches of legs by causing the apparatus to perform successive mutations on candidate solutions in the solution space through the addition or removal of one or more splitting points to increase an overall fitness of the candidate solutions; and
identify the selected solution of the candidate solutions, wherein the selected solution has an associated fitness metric.

3. The apparatus of claim 2, wherein causing the apparatus to perform successive mutations on candidate solutions in the solution space through the addition or removal of one or more splitting points to increase an overall fitness of the candidate solutions comprises causing the apparatus to:
at least one of add a splitting point within a trajectory or remove a splitting point between two legs in a trajectory.

4. The apparatus of claim 3, wherein causing the apparatus to perform successive mutations on candidate solutions in the solution space through the addition or removal of one or more splitting points to increase an overall fitness of the candidate solutions comprises causing the apparatus to:
change a bunch assignment of one or more legs.

5. The apparatus of claim 2, wherein causing the apparatus to identify the selected solution of the candidate solutions having an associated fitness metric comprises causing the apparatus to identify the selected solution of the candidate solutions having a fitness metric satisfying a predetermined threshold.

6. The apparatus of claim 5, wherein the fitness metric comprises a score reflecting one or more of lengths of the bunches of legs, a number of bunches, a number of legs within the bunches, or a distance metric between legs within a respective bunch of legs.

7. The apparatus of claim 1, wherein causing the apparatus to determine, from the bunches of legs, the selected solution of the map representation of the road network comprises causing the apparatus to determine the map representation of the road network without relying on underlying map data of an existing road network.

8. A computer program product comprising at least one non-transitory computer-readable storage medium having computer-executable program code instructions stored therein, the computer-executable program code instructions comprising program code instructions to:
receive a plurality of trajectories of probe data points from a plurality of probe apparatuses;
identify splitting points in each of the plurality of trajectories of probe data points;
identify legs of the plurality of trajectories of probe data points between pairs of splitting points;
assign legs into bunches of legs;
search a solution space determined by splitting point sections and leg bunch assignments;
determine, from the bunches of legs, a selected solution of a map representation of a road network; and
facilitate at least one of navigational assistance or at least semi-autonomous vehicle control using the map representation of the road network.

9. The computer program product of claim 8, wherein the program code instructions to search the solution space determined by splitting point and leg bunch assignments comprise program code instructions to:
perform a guided search of the solution space containing the bunches of legs by performing successive mutations on candidate solutions in the solution space through the addition or removal of one or more splitting points to increase an overall fitness of the candidate solutions; and
identify the selected solution of the candidate solutions, wherein the selected solution has an associated fitness metric.

10. The computer program product of claim 9, wherein the program code instructions to perform successive mutations on candidate solutions in the solution space through the addition or removal of one or more splitting points to increase an overall fitness of the candidate solutions comprise program code instructions to:
at least one of add a splitting point within a trajectory or remove a splitting point between two legs in a trajectory.

11. The computer program product of claim 10, wherein the program code instructions to perform successive mutations on candidate solutions in the solution space through the addition or removal of one or more splitting points to increase an overall fitness of the candidate solutions comprise program code instructions to:
change a bunch assignment of one or more legs.

12. The computer program product of claim 9, wherein the program code instructions to identify the selected solution of the candidate solutions having an associated fitness metric comprise program code instructions to identify the selected solution of the candidate solutions having a fitness metric satisfying a predetermined threshold.

13. The computer program product of claim 12, wherein the fitness metric comprises a score reflecting one or more of lengths of the bunches of legs, a number of bunches, a number of legs within the bunches, or a distance metric between legs within a respective bunch of legs.

14. The computer program product of claim 8, wherein the program code instructions to determine, from the bunches of legs, the selected solution of the map representation of the road network comprise program code instructions to determine the map representation of the road network without relying on underlying map data of an existing road network.

15. A method comprising:
receiving a plurality of trajectories of probe data points from a plurality of probe apparatuses;
identifying splitting points in each of the plurality of trajectories of probe data points;
identifying legs of the plurality of trajectories of probe data points between pairs of splitting points;
assigning legs into bunches of legs;
searching a solution space determined by leg bunch assignments;
determining, from the bunches of legs, a selected solution of a map representation of a road network; and
facilitating at least one of navigational assistance or at least semi-autonomous vehicle control using the map representation of the road network.

16. The method of claim 15, wherein searching the solution space determined by splitting point sections and leg bunch assignments comprises:
performing a guided search of the solution space containing the bunches of legs by performing successive mutations on candidate solutions in the solution space through the addition or removal of one or more splitting points to increase an overall fitness of the candidate solutions; and
identifying the selected solution of the candidate solutions, wherein the selected solution has an associated fitness metric.

17. The method of claim 16, wherein performing successive mutations on candidate solutions in the solution space through the addition or removal of one or more splitting points to increase an overall fitness of the candidate solutions comprises:
at least one of adding a splitting point within a trajectory or removing a splitting point between two legs in a trajectory.

18. The method of claim 17, wherein performing successive mutations on candidate solutions in the solution space through the addition or removal of one or more splitting points to increase an overall fitness of the candidate solutions comprises:
changing a bunch assignment of one or more legs.

19. The method of claim 16, wherein identifying the selected solution of the candidate solutions having an associated fitness metric comprises identifying the selected solution of the candidate solutions having a fitness metric satisfying a predetermined threshold.

20. The method of claim 19, wherein the fitness metric comprises a score reflecting one or more of lengths of the bunches of legs, a number of bunches, a number of legs within the bunches, or a distance metric between legs within a respective bunch of legs.
